(19) United States
(12) Patent Application Publication
(10) Pub. No.: US 2018/0213280 A1
(43) Pub. Date: Jul. 26, 2018

(54) DELIVERING VIDEO DATA AND POWER VIA A SINGLE DEVICE PORT

(71) Applicant: The DIRECTV Group, Inc., El Segundo, CA (US)

(72) Inventors: Premal Shah, Cerritos, CA (US); Carlos A. Moz, Chino Hills, CA (US); Viral R. Shah, Cerritos, CA (US)

(21) Appl. No.: 15/415,744

(22) Filed: Jan. 25, 2017

(51) Int. Cl. H04N 21/443; H04N 21/6336; H04N 21/61; H04N 21/436

(52) U.S. Cl. CPC H04N 21/4432; H04N 21/436; H04N 21/6143; H04N 21/6336

(57) ABSTRACT

In one example, the present disclosure describes a device, computer-readable medium, and method for the delivery of video data and power via a single device port. For instance, in one example, a device includes a processor and a computer-readable medium storing instructions which, when executed by the processor, cause the processor to perform operations. The operations include receiving a power signal via a first port of the device, receiving a data stream via the first port of the device, and decoding the data stream to extract displayable content from the data stream.

The present disclosure relates generally to the presentation of video programs, and more particularly to devices, non-transitory computer-readable media, and methods for delivering video data and power to a device via a single device port.

### BACKGROUND

Installation of satellite television service in a customer premises often requires the installation of various equipment and associated connectors for conveying power and data between the equipment (e.g., power adapters, power cords, data cables, etc.). For instance, each display device that is to receive the satellite signal may require a separate set top box (STB) for turning the satellite signal into content in a form that can be displayed on the display device. In turn, each STB may require a power cord to draw electrical power from the premises' mains electric, a data cable to receive the satellite signal from a receiver in communication with the satellite dish's transmitter, and potentially other connectors and/or adapters to facilitate the receipt of power and data in the appropriate forms.

### SUMMARY

In one example, the present disclosure describes a device, computer-readable medium and method for the delivery of video data and power via a single device port. For instance, in one example, a device includes a processor and a computer-readable medium storing instructions which, when executed by the processor, cause the processor to perform operations. The operations include receiving a power signal via a first port of the device, receiving a data stream via the first port of the device, and decoding the data stream to extract displayable content from the data stream.

In another example, a non-transitory computer-readable medium stores a plurality of instructions which, when executed by a processor, cause the processor to perform operations. The operations include receiving a power signal via a first port of the device, receiving a data stream via the first port of the device, and decoding the data stream to extract displayable content from the data stream.

In another embodiment, a set top box includes a processor and a computer-readable medium storing instructions which, when executed by the processor, cause the processor to perform operations. The operations include receiving a power signal via a first universal serial bus type C port of the set top box, receiving a data stream via the first universal serial bus type C port of the set top box, and decoding the data stream to extract displayable content from the data stream.

### BRIEF DESCRIPTION OF THE DRAWINGS

The teachings of the present disclosure can be readily understood by considering the following detailed description in conjunction with the accompanying drawings, in which:

FIG. 1 illustrates an example network related to the present disclosure;

FIG. 2 illustrates an example system for delivery of video data and power to a set top box in accordance with the present disclosure;

FIG. 3 illustrates a flowchart of an example method for delivering video data and power to a set top box in a customer premises in accordance with the present disclosure;

FIG. 4 illustrates a flowchart of another example method for delivering video data and power to a set top box in a customer premises in accordance with the present disclosure;

FIG. 5 depicts a high-level block diagram of a computing device specifically programmed to perform the functions described herein;

FIG. 6 illustrates an example system for delivery of video data and power to a display device in accordance with the present disclosure;

FIG. 7 illustrates an example system for exchange of video data and power between a server and a transmitter in accordance with the present disclosure; and

FIG. 8 illustrates an example system for exchange of video data and power between a server and a transmitter in accordance with the present disclosure.

To facilitate understanding, identical reference numerals have been used, where possible, to designate identical elements that are common to the figures.

### DETAILED DESCRIPTION

In one example, the present disclosure provides for the delivery of video data and power via a single device port. As discussed above, installation of satellite television service in a customer premises often requires the installation of various equipment and associated connectors (e.g., power adapters, power cords, data cables, etc.). This not only increases the cost of the components needed to deliver the service, but also may increase the power required to operate the components (e.g., power adapters, for example, require nominal power to operate). In addition, customers may find the presence of so many connectors in the premises to be unsightly and/or inconvenient.

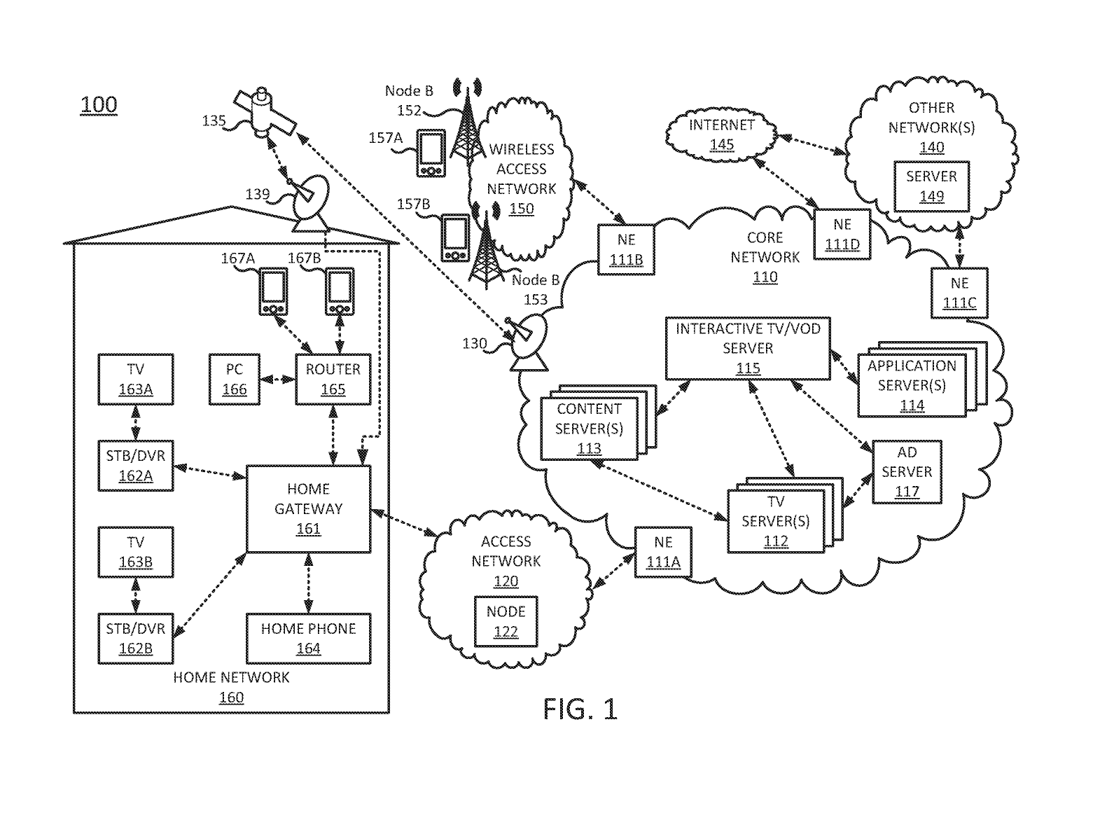

Examples of the present disclosure deliver video data and power via a single device port. For instance, examples of the present disclosure may make use of equipment (transmitters, receivers, and/or set top boxes (STBs)) that are provided with ports that can interface with connectors that provide both data streams and power signals (potentially simultaneously), i.e., in a single connector. One example of such a port is a universal serial bus type-C (USB-C) port, which can interface with a USB-C connector. This minimizes the number of connectors and ancillary components needed to deliver, for example, satellite television service. It also simplifies the design of the equipment (transmitters, receivers, and/or STBs) by minimizing the number of ports that are needed to connect the equipment. These and other aspects of the present disclosure are described in greater detail below in connection with the examples of FIGS. 1-8.

To better understand the present disclosure, FIG. 1 illustrates an example network 100, related to the present disclosure. As shown in FIG. 1, the network 100 connects mobile devices 157A, 157B, 167A and 167B, and home network devices such as home gateway 161, set-top boxes (STBs) 162A, and 162B, television (TV) 163A and TV 163B, home phone 164, router 165, personal computer (PC) 166, and so forth, with one another and with various other devices via a core network 110, a wireless access network 150 (e.g., a cellular network), an access network 120, other networks 140 and/or the Internet 145.

In one embodiment, wireless access network 150 comprises a radio access network implementing such technologies as: global system for mobile communication (GSM), e.g., a base station subsystem (BSS), or IS-95, a universal mobile telecommunications system (UMTS) network employing wideband code division multiple access (WCDMA), or a CDMA3000 network, among others. In other words, wireless access network 150 may comprise an access network in accordance with any “second generation” (2G), “third generation” (3G), “fourth generation” (4G), Long Term Evolution (LTE) or any other yet to be developed future wireless/cellular network technology. While the present disclosure is not limited to any particular type of wireless access network, in the illustrative embodiment, wireless access network 150 is shown as a UMTS terrestrial radio access network (UTRAN) subsystem. Thus, elements 152 and 153 may each comprise a Node B or evolved Node B (eNodeB).

In one embodiment, each of mobile devices 157A, 157B, 167A, and 167B may comprise any subscriber/customer endpoint device configured for wireless communication such as a laptop computer, a Wi-Fi device, a Personal Digital Assistant (PDA), a mobile phone, a smartphone, an email device, a computing tablet, a messaging device, and the like. In one embodiment, any one or more of mobile devices 157A, 157B, 167A, and 167B may have both cellular and non-cellular access capabilities and may further have wired communication and networking capabilities.

As illustrated in FIG. 1, network 100 includes a core network 110. In one example, core network 110 may combine core network components of a cellular network with components of a triple play service network; where triple play services include telephone services, Internet services and television services to subscribers. For example, core network 110 may functionally comprise a fixed mobile convergence (FMC) network, e.g., an IP Multimedia Subsystem (IMS) network. In addition, core network 110 may functionally comprise a telephony network, e.g., an Internet Protocol/Multi-Protocol Label Switching (IP/MPLS) backbone network utilizing Session Initiation Protocol (SIP) for circuit-switched and Voice over Internet Protocol (VoIP) telephony services. Core network 110 may also further comprise a broadcast television network, e.g., a traditional cable provider network or an Internet Protocol Television (IPTV) network, as well as an Internet Service Provider (ISP) network. The network elements 111A-111D may serve as gateway servers or edge routers to interconnect the core network 110 with other networks 140, Internet 145, wireless access network 150, access network 120, and so forth. As shown in FIG. 1, core network 110 may also include a plurality of television (TV) servers 112, a plurality of content servers 113, a plurality of application servers 114, an advertising server (AS) 117, and an interactive TV/video on demand (VOD) server 115 (e.g., an application server). For ease of illustration, various additional elements of core network 110 are omitted from FIG. 1.

With respect to television service provider functions, core network 110 may include one or more television servers 112 for the delivery of television content, e.g., a broadcast server, a cable head-end, and so forth. For example, core network 110 may comprise a video super hub office, a video hub office and/or a service office/central office. In this regard, television servers 112 may interact with content servers 113, advertising server 117, and interactive TV/VOD server 115 to select which video programs, or other content and advertisements to provide to the home network 160 and to others.

In one example, content servers 113 may store scheduled television broadcast content for a number of television channels, video-on-demand programming, local programming content, and so forth. For example, content providers may upload various contents to the core network to be distributed to various subscribers. Alternatively, or in addition, content providers may stream various contents to the core network for distribution to various subscribers, e.g., for live content, such as news programming, sporting events, and the like. In one example, advertising server 117 stores a number of advertisements that can be selected for presentation to viewers, e.g., in the home network 160 and at other downstream viewing locations. For example, advertisers may upload various advertising content to the core network 110 to be distributed to various viewers.

In one example, the access network 120 may comprise a Digital Subscriber Line (DSL) network, a broadband cable access network, a Local Area Network (LAN), a cellular or wireless access network, a 3^{rd} party network, and the like. For example, the operator of core network 110 may provide a cable television service, an IPTV service, or any other type of television service to subscribers via access network 120. In this regard, access network 120 may include a node 122, e.g., a mini-fiber node (MFN), a video-ready access device (VRAD) or the like. However, in another embodiment node 122 may be omitted, e.g., for fiber-to-the-premises (FTTP) installations. Access network 120 may also transmit and receive communications between home network 160 and core network 110 relating to voice telephone calls, communications with web servers via the Internet 145 and/or other networks 140, and so forth.

Alternatively, or in addition, the network 100 may provide television services to home network 160 via satellite broadcast. For instance, ground station 130 may receive television content from television servers 112 for uplink transmission to satellite 135. Accordingly, satellite 135 may receive television content from ground station 130 and may broadcast the television content to satellite receiver 139, e.g., a satellite link terrestrial antenna (including satellite dishes and antennas for downlink communications, or for both downlink and uplink communications), as well as to satellite receivers of other subscribers within a coverage area of satellite 135. In one example, satellite 135 may be controlled and/or operated by a same network service provider as the core network 110. In another example, satellite 135 may be controlled and/or operated by a different entity and may carry television broadcast signals on behalf of the core network 110.

In one example, home network 160 may include a home gateway 161, which receives data/communications associated with different types of media, e.g., television, phone, and Internet, and separates these communications for the appropriate devices. The data/communications may be received via access network 120 and/or via satellite receiver 139, for instance. In one example, television data is forwarded to set-top boxes (STBs)/digital video recorders (DVRs) 162A and 162B to be decoded, recorded, and/or forwarded to television (TV) 163A and TV 163B for presentation. Similarly, telephone data is sent to and received from home phone 164; Internet communications are sent to and received from router 165, which may be capable of both wired and/or wireless communication. In turn, router 165 receives data from and sends data to the appropriate devices, e.g., personal computer (PC) 166, mobile devices 167A, and 167B, and so forth. In one example, router 165 may further communicate with TV (broadly a display) 163A and/or 163B, e.g., where one or both of the televisions is a smart TV. In one example, router 165 may comprise a wired Ethernet router and/or an Institute for Electrical and Electronics Engineers (IEEE) 802.11 (Wi-Fi) router, and may communicate with respective devices in home network 160 via wired and/or wireless connections.

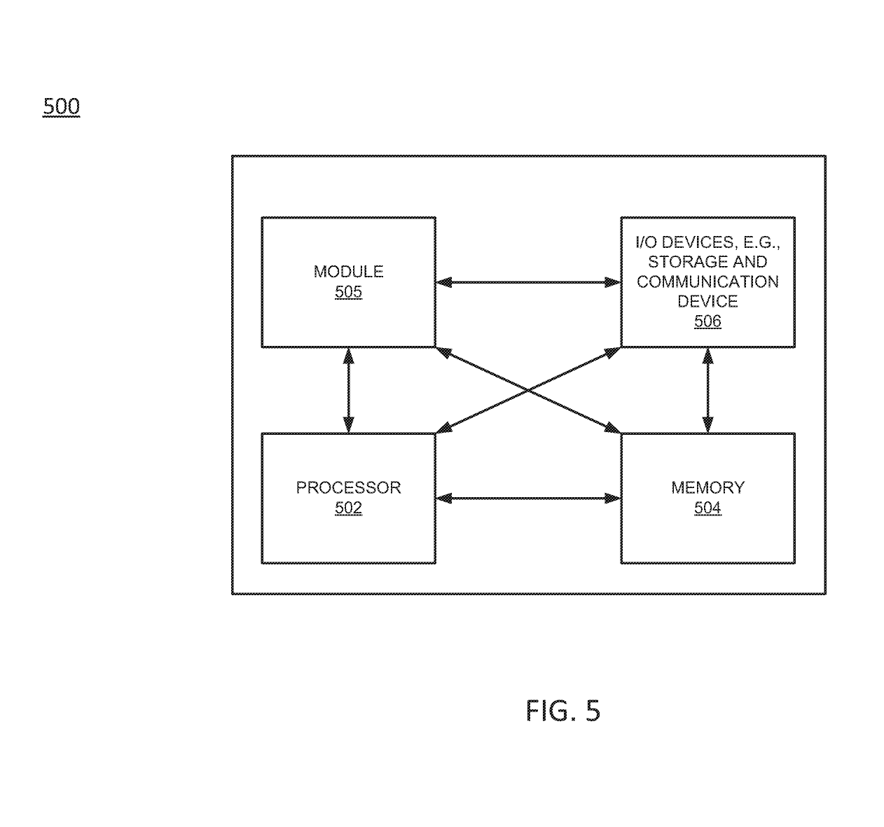

In one example, one or both of the STB/DVR 162A and STB/DVR 162B may comprise a computing system or server, such as computing system 500 depicted in FIG. 5, which includes a port that can interface with a connector that provides both data streams and power signals (potentially simultaneously). e.g., a USB-C port, as described herein. One or both of the STB/DVR 162A and STB/DVR 162B is further configured to decode data streams received via this port and to forward decoded data to a paired TV 163A or 163B for display. It should be noted that as used herein, the terms “configure” and “reconfigure” may refer to programming or loading a computing device with computer-readable/computer-executable instructions, code, and/or programs, e.g., in a memory, which when executed by a processor of the computing device, may cause the computing device to perform various functions. Such terms may also encompass providing variables, data values, tables, objects, or other data structures or the like which may cause a computer device executing computer-readable instructions, code, and/or programs to function differently depending upon the values of the variables or other data structures that are provided. For example, one or both of the STB/DVR 162A and STB/DVR 162B may host an operating system for presenting a user interface via TVs 163A and 163B, respectively. In one example, the user interface may be controlled by a user via a remote control or other control devices which are capable of providing input signals to a STB/DVR. For example, mobile device 167A and/or mobile device 167B may be equipped with an application to send control signals to STB/DVR 162A and/or STB/DVR 162B via an infrared transmitter or transceiver, a transceiver for IEEE 802.11 based communications (e.g., “Wi-Fi”), IEEE 802.15 based communications (e.g., “Bluetooth”, “ZigBee”, etc.), and so forth, where STB/DVR 162A and/or STB/DVR 162B are similarly equipped to receive such a signal. Although STB/DVR 162A and STB/DVR 162B are illustrated and described as integrated devices with both STB and DVR functions, in other, further, and different examples, STB/DVR 162A and/or STB/DVR 162B may comprise separate STB and DVR components.

Those skilled in the art will realize that the network 100 may be implemented in a different form than that which is illustrated in FIG. 1, or may be expanded by including additional endpoint devices, access networks, network elements, application servers, etc. without altering the scope of the present disclosure. For example, core network 110 is not limited to an IMS network. Wireless access network 150 is not limited to a UMTS/UTRAN configuration. Similarly, the present disclosure is not limited to an IP/MPLS network for VoIP telephony services, or any particular type of broadcast television network for providing television services, and so forth.

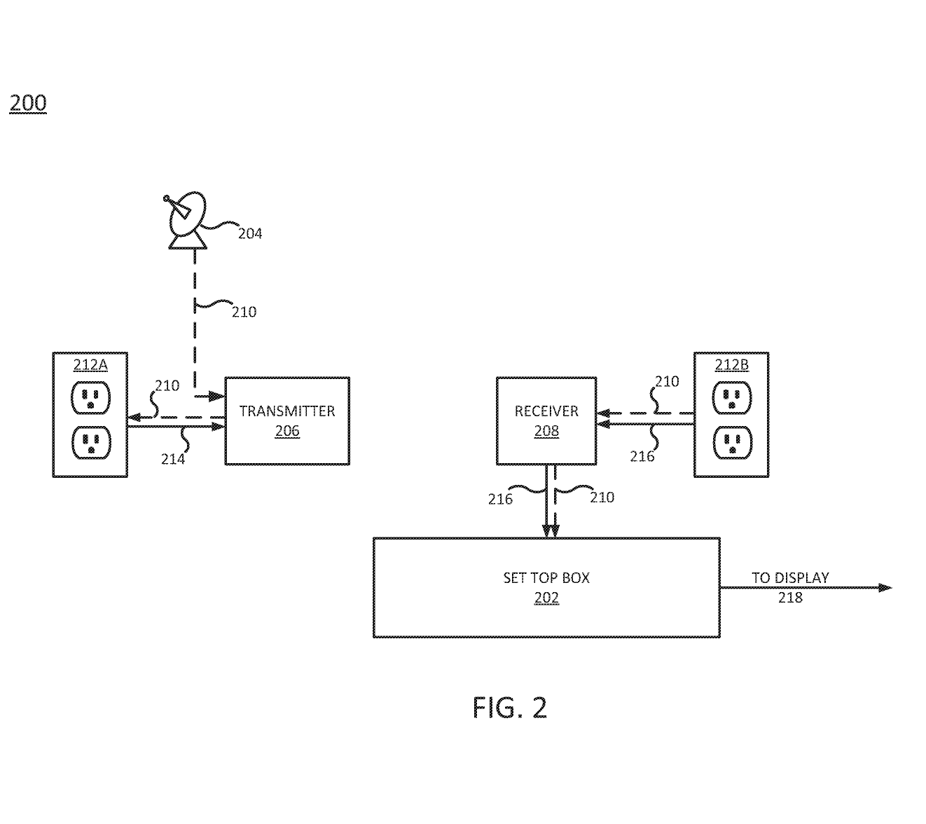

To further aid in understanding the present disclosure, FIG. 2 illustrates an example system 200 for delivery of video data and power to a set top box (STB) 202 in accordance with the present disclosure. As illustrated, the system 200 generally comprises a satellite receiver 204, a transmitting power adapter or “power adapter/transmitter” 206, a receiving power adapter or “power adapter/receiver” 208, and the STB 202. It should be noted that FIG. 2 illustrates only some of the customer premises equipment used to deliver the video data and power to the STB and omits other equipment that may not be located at the customer premises, such as the satellite that broadcasts the video data to the satellite receiver 204 and other equipment (e.g., as illustrated in FIG. 1).

The satellite receiver 204 may be a satellite link terrestrial antenna (e.g., including a satellite dish and one or more antennas for downlink and/or uplink communications), such as may be mounted to the exterior of the customer premises.

In one example, the power adapter/transmitter 206 comprises a radio frequency (RF) power adapter that includes a transceiver. The power adapter/transmitter 206 is coupled to the satellite receiver 204 (e.g., via a single-wire multiswitch (SWM) and/or coaxial RF connector) and is configured for receiving a data stream 210 directly from the satellite receiver 204. In one example, the data stream 210 is encrypted. In addition, the power adapter/transmitter 206 is coupled to the premises' mains electric, e.g., via a conventional power outlet 212A that delivers a power signal 214. This arrangement allows the power adapter/transmitter 206 to transmit the data stream 210 over the mains electric, e.g., in an RF signal. Thus, the mains electric in effect becomes an antenna for transmitting the data stream 210.

In one example, the power adapter/receiver 208 comprises an RF power adapter that includes a transceiver. The power adapter/receiver 208 is coupled to the premises' mains electric, e.g., via a conventional power outlet 212B that delivers a power signal 216. Since the data stream 210 is transmitted over the mains electric, the power adapter/receiver 208 may also receive the data stream 210 via the power outlet 212B. In a further example, the power adapter/receiver 208 includes a port over which it may (potentially simultaneously) deliver both the power signal 216 and the data stream 218 to a connected device, such as a USB-C port.

The STB 202 is coupled to the power adapter/receiver 208 and receives both the power signal 216 and the data stream 210 from the power adapter/receiver 208. In one example, the STB 202 includes a port that is capable of receiving both the data stream 210 and the power signal 216 (potentially simultaneously) from the power adapter/receiver 202. For instance, the port may be a USB-C port. In this case, the USB-C port of the STB 202 is connected to a USB-C port of the receiver 208, via a USB-C connector. The STB 202 decodes the data in the data stream 210 and delivers the decoded data 218 to a display, such as a television set.

The use of a single port, such as a USB-C port, to transmit both data streams and power signals (potentially simultaneously) to devices minimizes the number of connectors and ancillary equipment that are needed to connect the devices. It also simplifies the design of the devices (power adapters, transmitters, receivers, and/or STBs) by minimizing the number of ports that are needed to connect them and improves the power efficiency of the STB.

Moreover, USB-C connectors are compatible with the USB 3.1 data transfer protocol, which allows data to be transmitted at speeds of up to ten gigabytes per second (GB/s), or approximately twice as fast as the USB 3 protocol. USB-C also supports the THUNDERBOLT 3 hardware interface, which in turn may support bandwidths of up to forty gigabits per second (GBPS) and lower power consumption.

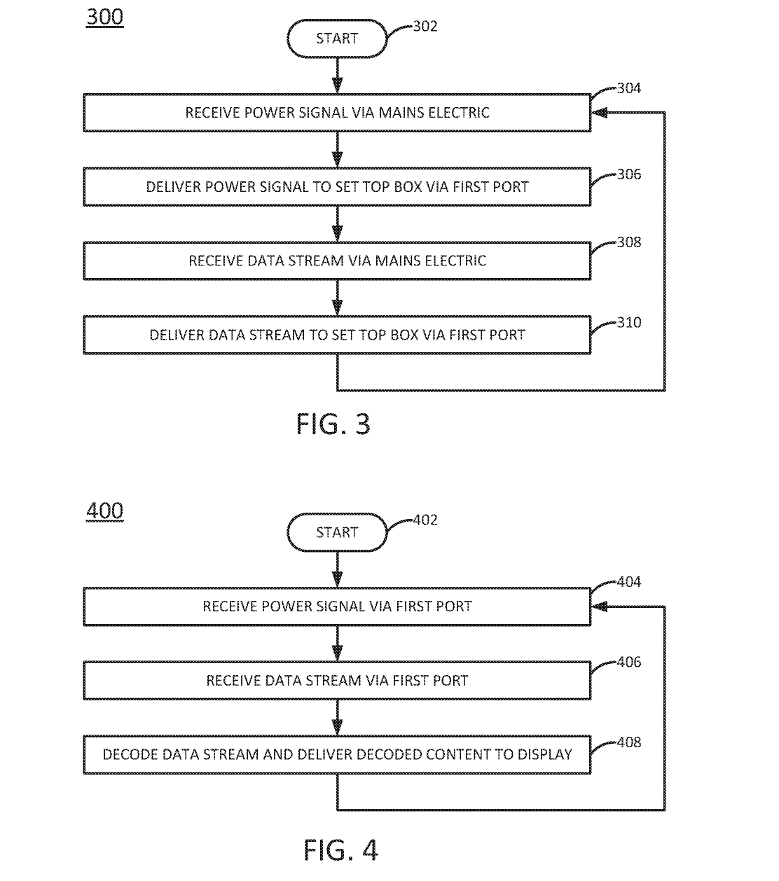

FIG. 3 illustrates a flowchart of an example method 300 for delivering video data and power to a set top box (STB) in a customer premises in accordance with the present disclosure. In one example, the method 300 may be performed by a receiving power adapter, such as the power adapter/receiver 208 illustrated in FIG. 2.

The method 300 begins in step 302. In step 304, the power adapter/receiver receives a power signal. For instance, the power signal may be delivered to the receiver via the customer premises' mains electric, e.g., using a connector that is coupled to a conventional power outlet in the customer premises.

In step 306, the power adapter/receiver delivers the power signal to the STB. In one example, the power signal is delivered to the STB via a first port of the power adapter/receiver. In a further example, the first port is a first USB-C port, and the first USB-C port is coupled to a second USB-C port on the STB (e.g., via a USB-C connector).

In step 308, the power adapter/receiver receives a data stream. The data stream may contain encrypted content, such as audio-visual content. In one example, the data stream is delivered to the power adapter/receiver via the customer premises' mains electric, e.g., using a connector that is coupled to a conventional power outlet in the customer premises.

In step 310, the power adapter/receiver delivers the data stream to the STB. In one example, the data stream is delivered to the STB via the first port of the power adapter/receiver. As discussed above, the first port may be a first USB-C port which is coupled to a second USB-C port on the STB (e.g., via a USB-C connector).

The method 300 loops back to step 304. Thus, the power adapter/receiver continues to receive a power signal and a data stream via the mains electric and to deliver the power signal and the data stream via the same port (e.g., a USB-C port) to a corresponding port on the STB until either the power signal, the data stream, or both are terminated, or until the power adapter/receiver, the STB, or both are powered down. Some of these steps may occur in parallel. For instance, since the data stream is transmitted via the mains electric, the power adapter/receiver may receive the power signal and the data stream (e.g., as indicated in steps and 308) simultaneously. Additionally, since the power adapter/receiver may be coupled to the STB via a USB-C or similar connector, the power adapter/receiver may deliver the power signal and the data stream to the STB (e.g., as indicated in steps 306 and 310) simultaneously. In a further example, all of steps 304-310 may be performed simultaneously as power and data are continuously received and transmitted by the power adapter/receiver.

FIG. 4 illustrates a flowchart of another example method 400 for delivering video data and power to a set top box (STB) in a customer premises in accordance with the present disclosure. In one example, the method 400 may be performed by a STB, such as the STB 202 illustrated in FIG. 2.

The method 400 begins in step 402. In step 404, the STB receives a power signal from a power adapter that includes a receiver, such as the power adapter/receiver 208 of FIG. 2. In one example, the power signal is received by the STB via a first port of the STB. In a further example, the first port is a first USB-C port, and the first USB-C port is coupled to a second USB-C port on the power adapter/receiver (e.g., via a USB-C connector).

In step 406, the STB receives a data stream from the power adapter/receiver. The data stream may contain encrypted content, such as audio-visual content. In one example, the data stream is received by the STB via the first port of the power adapter/receiver. As discussed above, the first port may be a first USB-C port which is coupled to a second USB-C port on the power adapter/receiver (e.g., via a USB-C connector).

In step 408, the STB decodes the data stream and delivers the decoded content to a display, such as a television set. The method 400 then loops back to step 404. Thus, the STB continues to receive a power signal and a data stream via the same port (e.g., a USB-C port) and to deliver decoded content from the data stream to a display device until either the power signal, the data stream, or both are terminated, until the connection to the display device is terminated, or until the display device, the STB, or both are powered down. Some of these steps may occur in parallel. For instance, since the data stream may be transmitted via the same port (e.g., a USB-C or similar port) as the power signal, steps 404 and 406 may occur simultaneously. Moreover, the STB may deliver decoded content to the display device while it continues to receive new encrypted data from the power adapter/receiver.

Although not expressly specified above, one or more steps of the method 300 or the method 400 may include a storing, displaying and/or outputting step as required for a particular application. In other words, any data, records, fields, and/or intermediate results discussed in the method can be stored, displayed and/or outputted to another device as required for a particular application. Furthermore, operations, steps, or blocks in FIG. 3 or FIG. 4 that recite a determining operation or involve a decision do not necessarily require that both branches of the determining operation be practiced. In other words, one of the branches of the determining operation can be deemed as an optional step. Furthermore, operations, steps or blocks of the above described method(s) can be combined, separated, and/or performed in a different order from that described above, without departing from the example embodiments of the present disclosure.

FIG. 5 depicts a high-level block diagram of a computing device specifically programmed to perform the functions described herein. For example, any one or more components or devices illustrated in FIG. 1 or described in connection with the method 300 or the method 400 may be implemented as the system 500. For instance, a power adapter including a transceiver element (such as might be used to perform the method 300) or an STB (such as might be used to perform the method 400) could be implemented as illustrated in FIG. 5.

As depicted in FIG. 5, the system 500 comprises a hardware processor element 502, a memory 504, a module 505 for delivering video data and power to a set top box (STB) in a customer premises, and various input/output (I/O) devices 506.

The hardware processor 502 may comprise, for example, a microprocessor, a central processing unit (CPU), or the like. The memory 504 may comprise, for example, random access memory (RAM), read only memory (ROM), a disk drive, an optical drive, a magnetic drive, and/or a Universal Serial Bus (USB) drive.

The module 505 for delivering video data and power to a STB in a customer premises includes circuitry and logic for performing special purpose functions, which may vary depending on the functionality of the system 500. For instance, where the system 500 is implemented as a power adapter including a transceiver element, the circuitry may include transformers, rectifiers, smoothing capacitors, voltage regulators, RF oscillators, modulators, filters, mixers, amplifiers, and/or other circuitry. Where the system 500 is implemented as an STB, the circuitry may include tuners, conditional access tables, demultiplexers, decoders, encoders, and/or other circuitry.

The input/output devices 506 may include, for example, a camera, a video camera, storage devices (including but not limited to, a tape drive, a floppy drive, a hard disk drive or a compact disk drive), a receiver, a transmitter, a speaker, a display, a speech synthesizer, an output port, and a user input device (such as a keyboard, a keypad, a mouse, and the like). In one example, one of the I/O devices 506 is a USB-C port configured for coupling to another device via a USB-C connector.

Although only one processor element is shown, it should be noted that the general-purpose computer may employ a plurality of processor elements. Furthermore, although only one general-purpose computer is shown in the Figure, if the method(s) as discussed above is implemented in a distributed or parallel manner for a particular illustrative example, i.e., the steps of the above method(s) or the entire method(s) are implemented across multiple or parallel general-purpose computers, then the general-purpose computer of this Figure is intended to represent each of those multiple general-purpose computers. Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable logic array (PLA), including a field-programmable gate array (FPGA), or a state machine deployed on a hardware device, a general purpose computer or any other hardware equivalents, e.g., computer readable instructions pertaining to the method(s) discussed above can be used to configure a hardware processor to perform the steps, functions and/or operations of the above disclosed method(s). In one embodiment, instructions and data for the present module or process 605 for delivering video data and power to a STB in a customer premises (e.g., a software program comprising computer-executable instructions) can be loaded into memory 504 and executed by hardware processor element 502 to implement the steps, functions or operations as discussed above in connection with the example method 300 or the example method 400. Furthermore, when a hardware processor executes instructions to perform “operations,” this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 505 for delivering video data and power to a STB in a customer premises (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. More specifically, the computer-readable storage device may comprise any physical devices that provide the ability to store information such as data and/or instructions to be accessed by a processor or a computing device such as a computer or an application server.

Examples of the present disclosure may be implemented in manners other than what is described above. For instance, the above examples describe only some ways in which the satellite receiver, power adapter/transmitter, power adapter/receiver, set top box, and display equipment may be connected.

For instance, in one example, data content could be forwarded to a display device via a power adapter including a receiver for receiving a data stream. The STB may be connected to the power adapter using a connector, such as a USB-C connector, while the power adapter may be coupled to mains electric. This example is illustrated in FIG. 2.

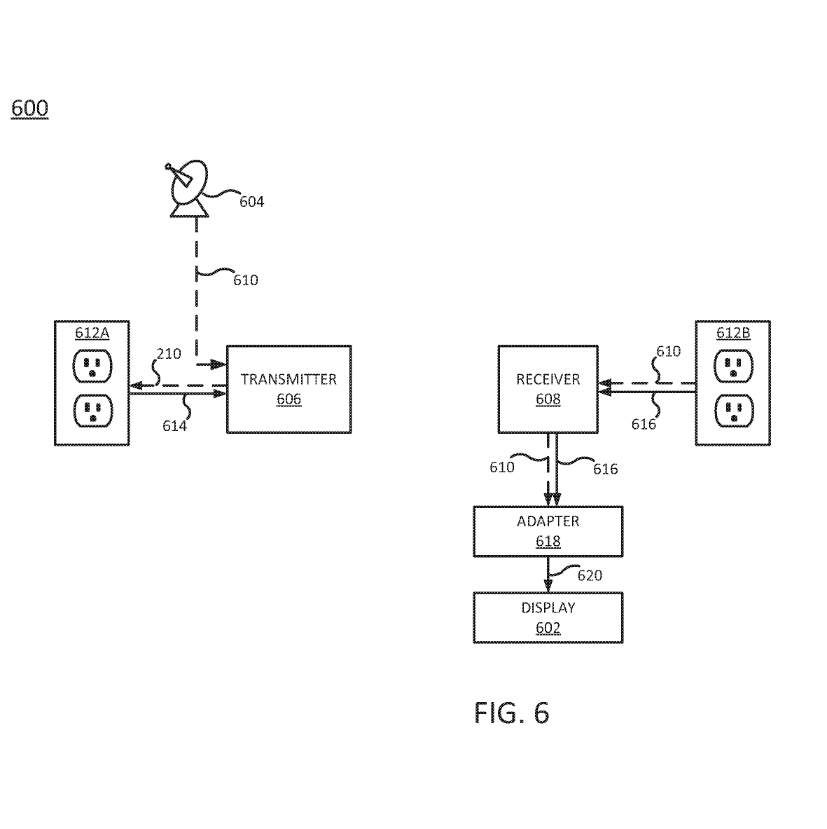

In another example, the STB may be replaced by an adapter and connector that connect the power adapter/receiver directly to the display device. FIG. 6, for instance, illustrates an example system 600 for delivery of video data and power to a display device 602 in accordance with the present disclosure. As illustrated, the system 600 generally comprises a satellite receiver 604, a transmitting power adapter or “power adapter/transmitter” 606, a receiving power adapter or “power adapter/receiver” 608, and the display device 602. It should be noted that FIG. 6 illustrates only some of the customer premises equipment used to deliver the video data and power to the display device 602 and omits other equipment that may not be located at the customer premises, such as the satellite that broadcasts the video data to the satellite receiver 604 and other equipment (e.g., as illustrated in FIG. 1).

The satellite receiver 604 may be a satellite link terrestrial antenna (e.g., including a satellite dish and one or more antennas for downlink and/or uplink communications), such as may be mounted to the exterior of the customer premises.

In one example, the power adapter/transmitter 606 comprises a radio frequency (RF) power adapter that includes a transceiver. The power adapter/transmitter 606 is coupled to the satellite receiver 604 (e.g., via a single-wire multiswitch (SWM) and/or coaxial RF connector) and is configured for receiving a data stream 610 directly from the satellite receiver 604. In one example, the data stream 610 is encrypted. In addition, the power adapter/transmitter 606 is coupled to the premises' mains electric, e.g., via a conventional power outlet 612A that delivers a power signal 614. This arrangement allows the power adapter/transmitter 606 to transmit the data stream 610 over the mains electric, e.g., in an RF signal. Thus, the mains electric in effect becomes an antenna for transmitting the data stream 610.

In one example, the power adapter/receiver 608 comprises an RF power adapter that includes a transceiver. The power adapter/receiver 608 is coupled to the premises' mains electric, e.g., via a conventional power outlet 612B that delivers a power signal 616. Since the data stream 610 is transmitted over the mains electric, the power adapter/receiver 608 may also receive the data stream 610 via the power outlet 612B. In a further example, the power adapter/receiver 608 includes a port over which it may simultaneously deliver both the power signal 616 and the data stream 610 to a connected device, such as a USB-C port.

An adapter 618 may be connected directly to the power adapter/receiver 608. In one example, the adapter 618 comprises a USB-C to high-definition multimedia interface (HDMI) adapter that receives the power signal 616 and the data stream 610 from the power adapter/receiver 608 via a single port and converts the data stream 610 into an HDMI signal.

The adapter 618 may be coupled to the display device 602. In one example, the display device 602 is a television that is compatible with the RVU software protocol, so that the display 602 device essentially functions as both the STB and the display. In one example, the display device 602 receives the HDMI signal 620 from the adapter via a connector, such as an HDMI cable. The display device 602 then decodes the data from the HDMI signal 620.

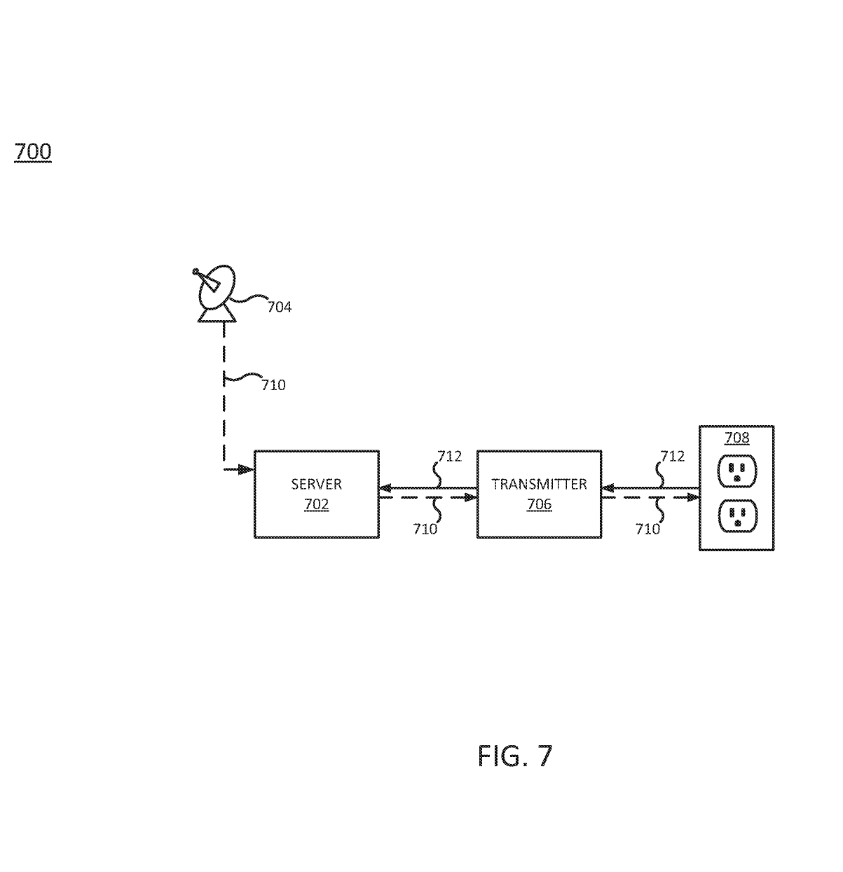

On the transmitter side, the satellite receiver could be connected directly to a server, which, in turn, could be connected directly to a power adapter/transmitter. FIG. 7, for instance, illustrates an example system 700 for exchange of video data and power between a server 702 and a power adapter/transmitter 706 in accordance with the present disclosure. As illustrated, the system 700 generally comprises a satellite receiver 704, a transmitting power adapter or “power adapter/transmitter” 706, and the server 702. It should be noted that FIG. 7 illustrates only some of the customer premises equipment used to exchange the video data and power and omits other equipment that may not be located at the customer premises, such as the satellite that broadcasts the video data to the satellite receiver 704 and other equipment (e.g., as illustrated in FIG. 1), as well as additional receiving and display equipment located in the customer premises.

The satellite receiver 704 may be a satellite link terrestrial antenna (e.g., including a satellite dish and one or more antennas for downlink and/or uplink communications), such as may be mounted to the exterior of the customer premises.

In one example, the server 702 is a receiver that may include digital video recorder (DVR) capabilities. The server 702 may be connected directly to the satellite receiver 704, e.g., via a single-wire multiswitch (SWM) and/or coaxial RF connector. The server 702 may be configured for receiving a data stream 710 directly from the satellite receiver 704. The data stream 710 may be encrypted. In addition, the server 702 may be connected to the power adapter/transmitter 706, such that the power adapter/transmitter 706 is able to deliver a power signal 712 from a conventional power outlet 708 to the server 702. In a further example, the server 702 includes a port over which it may (potentially simultaneously) both receive the power signal 712 from the power adapter/transmitter 706 and deliver the data stream 710 to the power adapter/transmitter 706, such as a USB-C port.

In one example, the power adapter/transmitter 706 comprises a radio frequency (RF) power adapter that includes a transceiver. The power adapter/transmitter 706 is coupled to the server 702 (e.g., via a USB-C connector) and is configured for receiving the data stream 710 directly from the server 702. In addition, the power adapter/transmitter 706 is coupled to the premises' mains electric, e.g., via the conventional power outlet 708 that delivers the power signal 712. This arrangement allows the power adapter/transmitter 706 to transmit the data stream 710 over the mains electric, e.g., in an RF signal. Thus, the mains electric in effect becomes an antenna for transmitting the data stream 710.

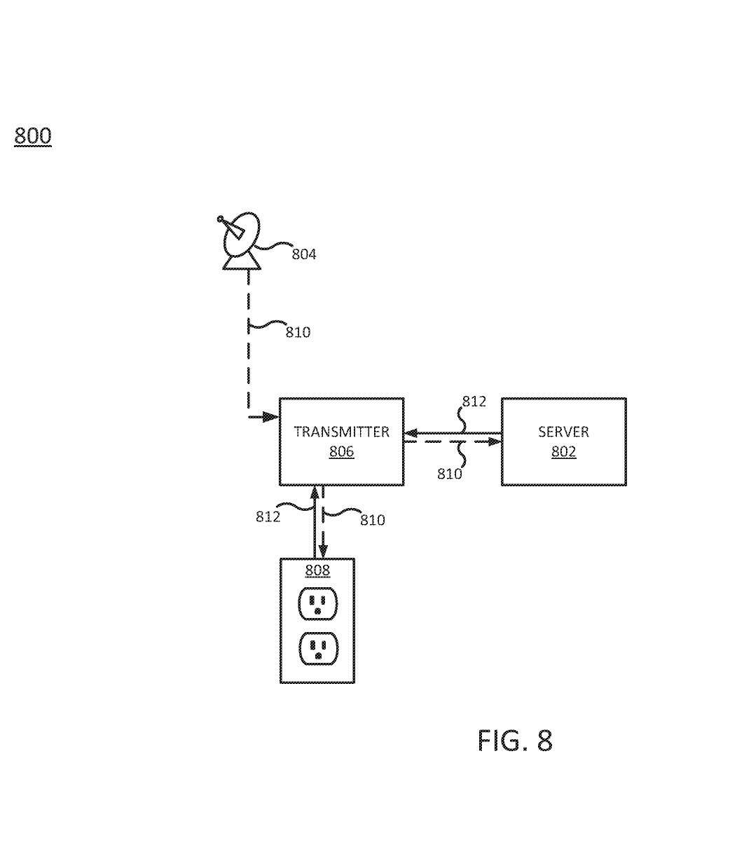

In another example, the satellite receiver could be connected directly to the power adapter/transmitter. The power adapter/transmitter could then be connected directly to a server. FIG. 8, for instance, illustrates an example system 800 for exchange of video data and power between a server 802 and a transmitter 806 in accordance with the present disclosure. As illustrated, the system 800 generally comprises a satellite receiver 804, a transmitting power adapter or “power adapter/transmitter” 806, and the server 802. It should be noted that FIG. 8 illustrates only some of the customer premises equipment used to exchange the video data and power and omits other equipment that may not be located at the customer premises, such as the satellite that broadcasts the video data to the satellite receiver 804 and other equipment (e.g., as illustrated in FIG. 1,) as well as additional receiving and display equipment located in the customer premises.

The satellite receiver 804 may be a satellite link terrestrial antenna (e.g., including a satellite dish and one or more antennas for downlink and/or uplink communications), such as may be mounted to the exterior of the customer premises.

In one example, the power adapter/transmitter 806 comprises a radio frequency (RF) power adapter that includes a transceiver. The power adapter/transmitter 806 is connected directly to the satellite receiver 804, e.g., via a single-wire multiswitch (SWM) and/or coaxial RF connector. The power adapter/transmitter 806 may be configured for receiving a data stream 810 directly from the satellite receiver 804. The data stream 810 may be encrypted. In addition, the power adapter/transmitter 806 is coupled to the premises' mains electric, e.g., via a conventional power outlet 808 that delivers the power signal 812. This arrangement allows the power adapter/transmitter 806 to transmit the data stream 810 over the mains electric, e.g., in an RF signal. Thus, the mains electric in effect becomes an antenna for transmitting the data stream 810. In a further example, the power adapter/transmitter 806 includes a port over which it may deliver (possibly simultaneously) both the power signal 812 and the data stream 810 to the server 802, such as a USB-C port.

In one example, the server 802 is a receiver that may include digital video recorder (DVR) capabilities. In a further example, the server 802 includes a port over which it may (potentially simultaneously) receive both the power signal 812 and the data stream 810 from the power adapter/transmitter 806, such as a USB-C port. In this case, the server 802 may be connected to the power adapter/transmitter 806 via a USB-C connector.

While various embodiments have been described above, it should be understood that they have been presented by way of example only, and not limitation. Thus, the breadth and scope of a preferred embodiment should not be limited by any of the above-described example embodiments, but should be defined only in accordance with the following claims and their equivalents.

1. A device, comprising:
a processor; and
a computer-readable medium storing instructions which, when executed by the processor, cause the processor to perform operations comprising:
receiving a power signal via a first port of the device from a mains electric of a premises;
receiving a data stream via the first port of the device over the mains electric of the premises; and
decoding the data stream to extract displayable content from the data stream.

2. The device of claim 1, wherein the operations further comprise:
delivering the displayable content to a display device.

3. The device of claim 2, wherein the device is a set top box.

4. The device of claim 1, wherein the first port is a universal serial bus type C port.

5. The device of claim 1, wherein the data stream is received in a radio frequency signal.

6. The device of claim 1, wherein the power signal and the data stream are received from a power adapter including a transceiver, and the first port is connected to a second port on the power adapter.

7. The device of claim 6, wherein the first port is connected to the second port via a universal serial bus type C connector.

8. A non-transitory computer-readable medium storing a plurality of instructions which, when executed by a processor, cause the processor to perform operations comprising:
receiving a power signal via a first port of the device from a mains electric of a premises;
receiving a data stream via the first port of the device over the mains electric of the premises; and
decoding the data stream to extract displayable content from the data stream.

9. The non-transitory computer-readable medium of claim 8, wherein the operations further comprise:
delivering the displayable content to a display device.

10. The non-transitory computer-readable medium of claim 9, wherein the processor is implemented in a set top box.

11. The non-transitory computer-readable medium of claim 8, wherein the first port is a universal serial bus type C port.

12. The non-transitory computer-readable medium of claim 8, wherein the data stream is received in a radio frequency signal.

13. The non-transitory computer-readable medium of claim 8, wherein the power signal and the data stream are received from a power adapter including a transceiver, and the first port is connected to a second port on the power adapter.

14. The non-transitory computer-readable medium of claim 13, wherein the first port is connected to the second port via a universal serial bus type C connector.

15. The non-transitory computer-readable medium of claim 8, wherein the data stream comprises television content broadcast via satellite.

16. A set top box, comprising:
a processor; and
a computer-readable medium storing instructions which, when executed by the processor, cause the processor to perform operations comprising:
receiving a power signal via a first universal serial bus type C port of the set top box from a mains electric of a premises;
receiving a data stream via the first universal serial bus type C port of the set top box over the mains electric of the premises; and
decoding the data stream to extract displayable content from the data stream.

17. The set top box of claim 16, wherein the operations further comprise:
delivering the displayable content to a display device.

18. The set top box of claim 16, wherein the data stream is received in a radio frequency signal.

19. The set top box of claim 16, wherein the power signal and the data stream are received from a power adapter including a transceiver, and the first universal serial bus type C port is connected to a second universal serial bus type C port on the power adapter.

20. The set top box of claim 19, wherein the first universal serial bus type C port is connected to the second universal serial bus type C port via a universal serial bus type C connector.
